(19) United States
(12) Patent Application Publication
(10) Pub. No.: US 2024/0233542 A9
(43) Pub. Date: Jul. 11, 2024

(54) OBJECT DETECTION AND PREDICTIVE MOTION WARNING FOR VEHICLE

(71) Applicant: GM GLOBAL TECHNOLOGY OPERATIONS LLC, Detroit, MI (US)

(72) Inventors: Umer Khalid, Farmington Hills, MI (US); Russell A. Patenaude, Macomb Township, MI (US)

(73) Assignee: GM GLOBAL TECHNOLOGY OPERATIONS LLC, Detroit, MI (US)

(21) Appl. No.: 17/969,806

(22) Filed: Oct. 20, 2022

(51) Int. Cl. G08G 1/16; B60Q 9/00; G01P 13/00; G07C 5/02

(52) U.S. Cl. CPC G08G 1/16; B60Q 9/00; G01P 13/00; G07C 5/02

(57) ABSTRACT

An object detection and predictive motion warning system for a vehicle. The system may include a plurality of weight sensors configured to generate weight values in response to pressure being applied thereto and an object detection and predictive motion controller configured to detect an object within the vehicle and to predict a motion assessment for the object as function thereof.

### INTRODUCTION

The present disclosure relates to object detection and predictive motion warning for a vehicle, such as but not necessarily limited to detecting unsecured objects placed upon non-passenger cargo areas of the vehicle and predictively generating a motion warning.

Objects and other items left unsecured in a vehicle may become mobile while a vehicle is in motion, which may result in the unsecured objects potentially contacting occupants within the vehicle, falling off of or outside of the vehicle, shifting in an undesirable way, or changing in an unforeseen and unexpected manner. In an effort to mitigate these possibilities, it may be desirable to warn the driver or other occupants of unsecured objects, to take corrective measures to secure the objects, to implement vehicle controls, and/or to undertake other activities to minimize consequences associated with unsecured objects.

### SUMMARY

One non-limiting aspect of the present disclosure relates to an object detection and predictive motion warning system for a vehicle whereby the system may be operable to detect objects, items, etc. within the vehicle and to generate a corresponding motion assessment, which may include determining whether the objects may be unsecured or otherwise placed within the vehicle in such a manner as to potentially contact vehicle occupants, fall off of or outside of the vehicle, shift in an undesirable way, and/or change in an unforeseen and unexpected manner. The system may be operable to detect, predict, and warn occupants about items left in unsecure positions as well as if any occupants may be sitting in unsafe ways themselves. The system may include sensors for detecting motion, weight, and/or slipping of objects in cooperation with vehicle sensors to predict and reduce the risk of people and items moving unexpectedly and abruptly. The system may be leveraged to assist in stabilizing cargo, reducing non-secure moving objects on front and/or rear dash from becoming a projectile, reducing object interactions with live beings while the vehicle is moving, and improving driving when the vehicle has cargo that may shift with vehicle momentum. The system may be configured to provide real-time and historical data collection of driving behavior, which may be used to provide a probability of hard braking/acceleration along with an algorithmic output correlating those events to the likelihood of slipping based on weight, position, and previous motion to create a severity rank and/or other motion assessment.

One non-limiting aspect of the present disclosure relates an object detection and predictive motion warning system for a vehicle. The system may include a plurality of weight sensors configured to generate weight values in response to pressure being applied upon exposed surfaces included within one or more of plurality of non-passenger cargo areas of the vehicle, a plurality of vehicle monitors configured to generate vehicle data for one or more operations of the vehicle, and an object detection and predictive motion controller configured to detect an object within one of the non-passenger cargo areas and to predict a motion assessment for the object as function of the weight values and the vehicle data.

The motion assessment may include determining a motion of the object to be either dependent on or independent of the vehicle. The motion may be determined to be dependent on the vehicle in response to the motion resulting from vehicle forces generated with movement of the vehicle. The motion may be determined to be independent of the vehicle in response to the motion resulting from non-vehicle forces generated separately from movement of the vehicle. The object detection and predictive motion controller may be configured to generate a shifting load warning for an occupant of the vehicle in response to the motion being dependent on the vehicle and to generate a live cargo warning for an occupant of the vehicle in response to the motion being independent of the vehicle, optionally with a timing report for indicating a duration of movement for the object following communication of the live cargo warning.

The motion assessment may include determining a motion of the object to be one of stationary or non-stationary while the vehicle is stationary. The object detection and predictive motion controller may be configured to generate a live cargo warning for a driver of the vehicle in response to the motion being non-stationary. The object detection and predictive motion controller may be configured to inhibit movement of the vehicle after generating the live cargo warning and until detecting the driver providing an acknowledgement in response thereto. The object detection and predictive motion controller may be configured to make a persistent presence assessment in response to the motion being stationary, including the persistent presence assessment determining the object to be an old load in response to determining the object to have been present during a prior ignition cycle and a new load in response to determining the object to have been absent during a prior ignition cycle. The object detection and predictive motion controller may be configured to generate an old load present warning for an occupant of the vehicle in response to determining the old load and to generate a new load present warning for an occupant of the vehicle in response to determining the new load, optionally with a size and/or a weight of the object being included as part of the new load present warning.

The object detection and predictive motion controller may be configured to generate a warning for an occupant of the vehicle as a function of the motion assessment.

The object detection and predictive motion controller may be configured to transmit the motion assessment to a back office configured for monitoring driver behavior and safety.

One non-limiting aspect of the present disclosure relates to an object detection and predictive motion warning system for a vehicle having a front fascia surface exposed below a front windshield and a rear fascia surface exposed below a rear windshield. The system may include a plurality of weight sensors configured to generate weight values in response to pressure being applied upon the front and rear fascia surfaces, a plurality of vehicle monitors configured to generate vehicle data for one or more operations of the vehicle, and an object detection and predictive motion controller configured to detect an object upon one of the front and rear fascia surfaces and to predict a motion assessment for the object as function of the weight values and the vehicle data.

One non-limiting aspect of the present disclosure relates to an object detection and predictive motion warning system for a vehicle having a truck bed. The system may include a plurality of weight sensors configured to generate weight values in response to pressure being applied to the truck bed, a plurality of vehicle monitors configured to generate vehicle data for one or more operations of the vehicle, and an object detection and predictive motion controller configured to detect an object upon the truck bed and to inhibit movement of the vehicle in response to the weight values and the vehicle data indicating the object to be a live person

The above features and advantages along with other features and advantages of the present teachings are readily apparent from the following detailed description of the modes for carrying out the present teachings when taken in connection with the accompanying drawings. It should be understood that even though the following Figures and embodiments may be separately described, single features thereof may be combined to additional embodiments.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 illustrates a schematic view of an object detection and predictive motion warning system for a vehicle in accordance with one non-limiting aspect of the present disclosure.

FIG. 2 illustrates a schematic view of the object detection and predictive motion warning system for use with a truck bed or other uncovered cargo area in accordance with one non-limiting aspect of the present disclosure.

FIG. 3 illustrates a flowchart of a method for object detection and predictive motion warning in accordance with one non-limiting aspect of the present disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

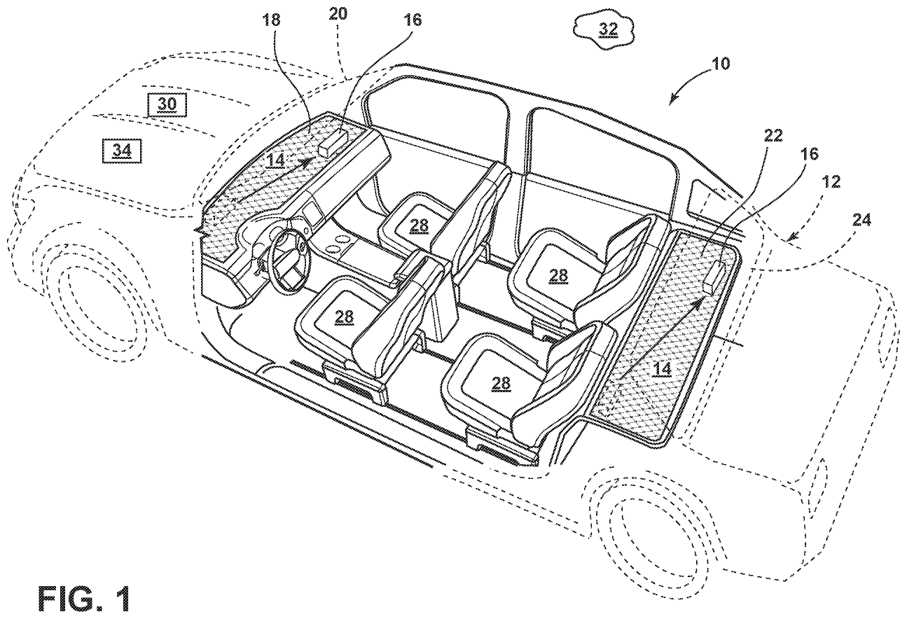

FIG. 1 illustrates a schematic view of an object detection and predictive motion warning system 10 for a vehicle 12 in accordance with one non-limiting aspect of the present disclosure. The system 10 may include a plurality of pressure, mesh, or other type of sensors 14, which may be collectively referred to herein in a non-limiting and illustrative manner as weight sensors 14, configured to generate weight values or other measurements in response to pressure or other forces being applied thereto. The weight sensors 14 may be configured, for example, to register pressure, load, force, etc. when an item, package, cell phone, person, purse, car seat, stuffed animal, or other object 16 is placed thereupon. The weight sensors 14 are shown in FIG. 1 for exemplary purposes as being positioned, integrated, or otherwise included as part of or as a cosmetic additional to a front fascia surface 18 exposed below a front windshield 20 and a rear fascia surface 22 expose below a rear windshield 24. The weight sensors 14 may be disposed below an outer leather or fabric layer of the corresponding surface 18, 22 such that the weight sensors 14 may conform with the exposed surface 18, 22 while being out of view or otherwise unidentifiable to the vehicle 12 occupants. The weight sensors 14 are predominantly described as being disposed within non-passenger cargo areas for exemplary purposes as the present disclosure fully contemplates the weight sensors 14 being included within passenger areas of vehicle 12, such as within the passenger seats 28.

The weight sensors 14 may have a dispersed pattern of discrete pressure sensors spread thereacross such that the weight sensors 14 may be configured to assess pressure across an entirety of the sensed surface 18, 22, e.g., the weight sensors 14 may be configured to sense pressure applied to any portion of the front and rear fascia surfaces 18, 22. The present disclosure fully contemplates the weight sensors 14 being disposed elsewhere within the vehicle 12, optionally within other passenger and/or non-passenger cargo areas of the vehicle 12, and are merely presented with respect to the front and rear fascia surfaces 18, 22 in order to illuminate the benefits of the present disclosure with respect to detecting and warning of unsecured objects 16 being placed thereupon, particularly in light of the front and rear fascia surfaces 18, 22 tending to correspond with non-passenger cargo areas of the vehicle 12 upon which occupants may frequently place objects 16 without realizing that objects 16 may become unsecured and/or areas of the vehicle 12 where objects 16 may be placed without the vehicle 12 occupants realizing the ramifications of the objects 16 potentially disengaging from the placed upon surface 18, 22 or otherwise becoming mobile with movement of the vehicle 12.

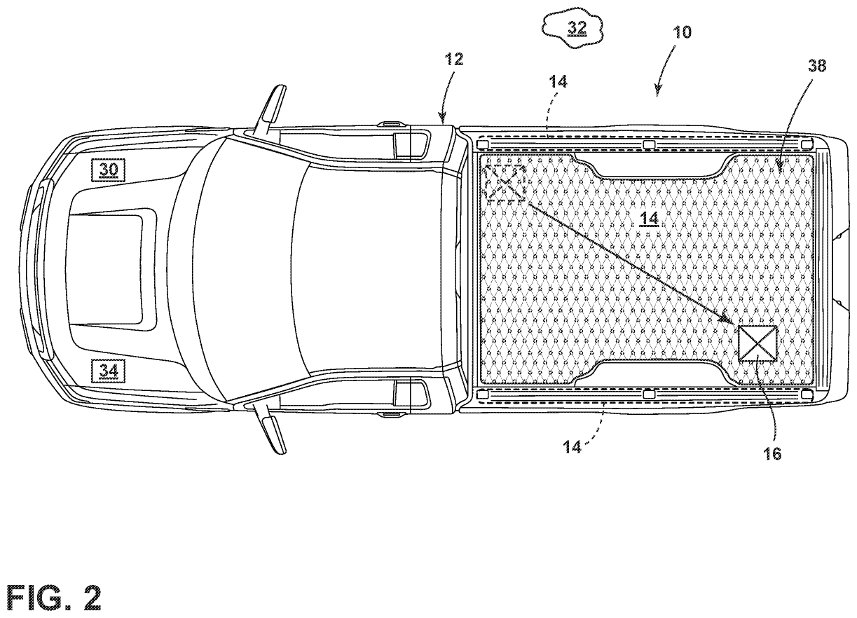

The system 10 may include a plurality of monitors 30 configured to generate vehicle 12 data associated with operation of one or more vehicle systems (not shown). The vehicle monitors 30, for example, may be configured to monitor operating conditions, parameters, values, metrics, etc. for the various vehicle systems included within the vehicle 12 to facilitate the operations associated therewith, such as the vehicle monitors 30 being configured to generate vehicle data for a powertrain system (e.g., gas and/or electric), a braking system, an infotainment system, a navigation system, a heating, ventilation, and air conditioning (HVAC) system, a radar system, a communication system, a global positioning system (GPS), and the other systems and subsystems one skilled in the art will appreciate as typically being be included within the vehicle 12, particularly the illustrated passenger automobile illustrated in FIG. 1 and the cargo truck illustrated in FIG. 2. The vehicle monitors 30 are illustrated for exemplary purposes as being included onboard the vehicle 12 as the present disclosure fully contemplates the vehicle 12 monitors, or portions thereof, being located off for the vehicle 12, such as at a back office 32 of the vehicle's manufacturer and/or at another remote location having capabilities to wirelessly communicate with the vehicle 12 to facilitate the object detection and warning contemplated herein.

The system 10 may include an object detection and predictive motion controller 34 configured to detect objects 16 within the vehicle 12 and to predict a motion assessment for each of the objects 16 as a function of the weight values and vehicle data collected with the weight sensors 14 and/or the vehicle monitors 30. The controller 34, for example, may be configured to detect the presence of objects 16 based on the weight values reflecting those objects 16 pressing down upon or otherwise engage with the non-passenger cargo surface 18, 22 within the vehicle 12, e.g., being placed upon the front and/or rear fascia surfaces 18, 22. The controller 34 may include a processor and a computer readable storage medium having a plurality of non-transitory instructions stored thereon, which when executed with the processor, may be sufficient to facilitate utilizing the weight values to detect the objects 16 and the vehicle 12 data to predict the likelihood of the each object 16 becoming mobile with movement of the vehicle 12, e.g., the objects 16 being unsecured, and if or when beneficial, to generate a corresponding warning to a vehicle occupant, or in some cases, to inhibit or otherwise execute control over one or more vehicle systems to prevent or mitigate the probability of the objects 16 becoming mobile.

The controller 34 may store the weight values and other pressure readings determined with the sensors 14 over time to track changes, differences, and uses of the sensed surfaces 18, 22, such as to generate benchmarks or baselines of pressure readings made while no objects 16 are disposed upon the weight sensors 14 versus when objects 16 are placed thereon. One non-limiting aspect of the present disclosure contemplates the weight sensors 14 and/or the controller 34 being configured to detect the presence of objects 16 within the vehicle 12 in a passive manner, which may optionally occur without interrogating or otherwise specifically identifying the objects 16 through other means besides the weight values. The capability of the present disclosure to detect the objects 16 in such a passive manner may be beneficial in providing object detection without the complication and expense of radio frequency identifiers (RFIDs), cameras, or more sophisticated componentry and/or without passengers having to be concerned with the object detection and predictive motion warning system 10 compromising their privacy by generating images, renderings, or other personal or precise identification of the passengers and/or the objects 16.

FIG. 2 illustrates a schematic view of the object detection and predictive motion warning system 10 when the vehicle 12 is a truck or other cargo type of transport having a truck bed or other uncovered cargo area 38 in accordance with one non-limiting aspect of the present disclosure. The vehicle 12 may include weight sensors 14 in the truck bed 38 in addition to or in place of the weight sensors 14 within a passenger compartment, i.e., the truck 12 may include interior with pressure sensors in a manner similar to that described above with respect to FIG. 1. The weight sensors 14 may be dispersed below a bedliner and/or within bed rails and/or sidewalls of the truck bed 38, e.g., the sensors 14 may be arranged to register pressure for objects 16 placed upon the truck bed and/or on top of or against a top or a side of the bed rails. One non-limiting aspect of the present disclosure contemplates the truck bed 38 being representative of an exposed or an exterior cargo area where unsecured objects 16 may move about, and in some situations, fall off of or outside of the vehicle 12. The ability to detect such unsecured objects 16 and to generate corresponding warnings and/or limits on operation of the vehicle 12 may be beneficial in mitigating an ability of the objects 16 affecting other vehicles and/or to prevent live persons from riding in the back of the vehicle 12.

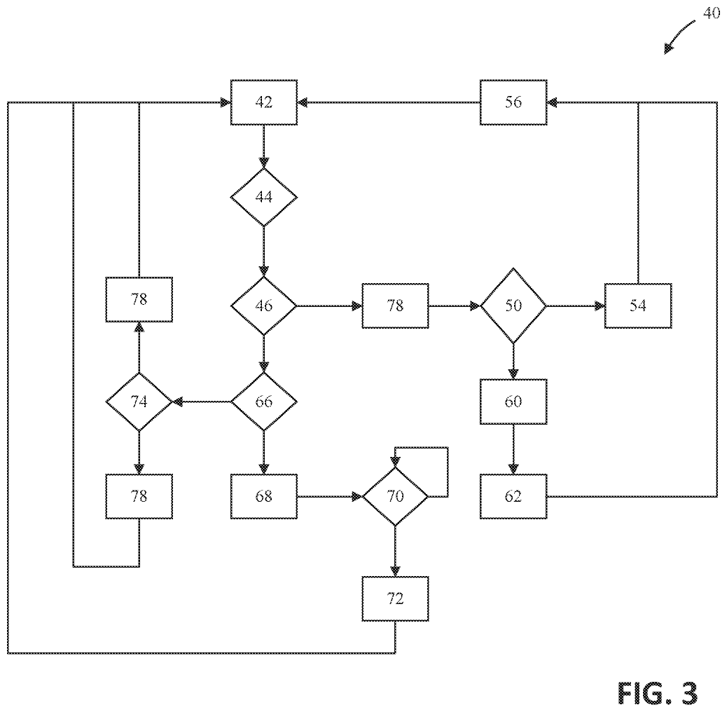

FIG. 3 illustrates a flowchart 40 of a method for object detection and predictive motion warning in accordance with one non-limiting aspect of the present disclosure. Block 42 relates to a reading process whereby the object detection and predictive motion controller 34 may be configured to retrieve or otherwise obtain the weight values from the weight sensors 14, which may be deployed within a vehicle 12, such as within the above-described front fascia surface 18, rear fascia surface 22, and/or truck bed 38 or in a non-illustrated manner within other passenger and/or non-passenger areas of the vehicle 12. The weight sensors 14 are predominantly described as sensors configured to register pressure when objects 16 are placed thereon, however, this is done for non-limiting purposes as the present disclosure fully contemplates other types of sensors being employed, e.g., rather than sensing pressure or in addition to sensing pressure, the sensors may be configured to detect motion or other aspects of the objects 16. The reading process may include collecting weight values and/or other information sufficient to facilitate detecting objects 16 within the vehicle 12.

Block 44 relates to an object detection process whereby the information collected through the reading process may be continuously monitored process to determine whether one or more objects 16 are present within the vehicle 12, or more specifically, whether one or more objects 16 placed upon the weight sensors 14, i.e., whether objects 16 have been placed upon the sensed surfaces 18, 22, 38 where text may be frequently unsecured and/or forgotten. The object detection process may occur each time an object 16 is detected to be present within the vehicle 12, upon vehicle 12 ignition cycling from a stopped stated or to running and/or powered state, when the sensor values change (e.g., when a passenger places their foot or another object 16 on the front fascia surfaces 18 while the vehicle 12 is in transit) and/or respond to another triggering event. The process may include simultaneously detecting multiple objects 16 and collecting corresponding weight values for each. The collected weight values may include a numerical representation of the weight, a location and/or area where pressure is being sensed, a timestamp, and/or other sensed information, e.g., temperature, texture, etc.

Block 46 relates to a transmission process associated with determining whether a transmission of the vehicle 12 is in park in response to the object detection process determining one or more objects 16 to be present with the vehicle 12. The transmission process may be used to assess an operating state of the vehicle 12, which for exemplary purposes is described with respect to determining whether or not the vehicle 12 is being driven, operated, or otherwise active at the time of detecting an object 16 on one of the weight sensors 14 depending on whether as the transmission is in park. This may include, for example, determining the vehicle 12 to be stationary when the transmission is in park and to be non-stationary when the transmission is not in park, e.g., when the transmission is drive, neutral, or reverse. Block 48 relates to a vehicle data collection process whereby vehicle data and other information may be collected with the vehicle monitors 30 in the event the vehicle 12 is determined in Block 46 to be active. The vehicle data collection process may include a comparison process for comparing the vehicle data with the weight values to facilitate predicting or generating a motion assessment for each object 16.

Block 50 relates to a motion process for determining a motion, if any, of each object 16 to be either depended on or independent of the vehicle 12. Block 50 may be reached, for example, in the event the object detection process detects an object 16 being placed upon one of the sensed surfaces 18, 22, 38 after the vehicle 12 starts traveling to a destination, such as in response to an occupant placing a mobile device on the rear fascia 22 or a front passenger placing a foot upon the front fascia 18. The object motion may be determined to be dependent on the vehicle 12 in response to the motion resulting from vehicle forces and momentum generated as a result of movement of the vehicle 12, e.g., in response to forces imparted while driving the vehicle 12. The vehicle dependent motion may occur with the object 16 shifting in concert with momentum of the vehicle 12, such as the occupant's leg slightly rotating when place on the front fascia 18. The vehicle dependent motion may also occur without the object 16 changing locations or moving to another area of the sensed surface 18, 22, 38, i.e., the object 16 may be considered to have moved in dependence on the vehicle 12 due to the object 16 providing more or less pressure in a manner consistent with operation of the vehicle 12. The object 16 motion, in contrast, may be determined to be independent of the vehicle 12 in response to the motion resulting from non-vehicle forces generated separately from movement of the vehicle 12, e.g., a passenger moving the object 16 and/or the object 16 moving on its own, such as due to the object 16 being a live person or animal or otherwise capable of self-directed movement.

Block 54 relates to a shifting load process for generating a shifting load warning for an occupant of the vehicle 12 in response to the object 16 motion being dependent on the vehicle 12. The object 16 shifting warning may be interfaced with an occupant or a driver of the vehicle 12 through an infotainment system, alert, or other messaging, such as through a phone or personal device, to provide notification of the object 16 having shifted positions, e.g., the object 16 may have shifted from an original position when initially placed on the sensed surface to another position due to movement of the vehicle 12, such as in the manner shown the arrowed lines. The shifting load warning may also be generated without the object 16 having to physically move to another location, such as if further movement of the object 16 may be predicted, e.g., it may be predictable for the object 16 to shift in the event the object 16 (e.g. front passenger's leg) is place upon an airbag and the airbag is deployed during operation of the vehicle 12. The vehicle 12 occupant may use the warning to identify the shifted object 16 and/or to take corrective measures, such as to place the object 16 in a trunk of the vehicle 12 or remove the passenger's leg from the front fascia 18. The shifting load warning may be characterized as a motion assessment for the object 16 in so far as being indicative of the object 16 having actually shifted or otherwise being likely to shift unless properly secured.

Block 56 relates to a reporting process whereby the motion assessment associated with the shifting load warning may be transmitted or otherwise reported, such as through remote transmission to a back office 32 or other entity tasked with monitoring driver behavior and safety. The reporting process may include timestamps, geolocation information, weight values, vehicle data, and other information processed as part of generating the shifted shifting load warning. This type of data collection reporting process may enable ongoing review and monitoring of driver behavior and safety, which may be useful in providing feedback to the driver to avoid repeated exposure to unsecured objects 16, performing accident investigations, etc.

Block 60 relates to a live cargo process for generating a live cargo warning for an occupant of the vehicle 12 in response to the object 16 motion being independent of the vehicle 12. The live cargo warning may be interfaced with an occupant or a driver in a similar manner to the shifting load warning, which may be similarly used to identify the live object 16 and/or to take corrective measures for the securement thereof. One non-limiting aspect of the present disclosure contemplates the motion process being useful in classifying the object 16 according to the type of motion so that alternative actions may be permitted as a function thereof. The illustrated differentiation may be based on whether the object 16 is moved itself or whether it has moved as result of vehicle 12 movement. In some situations, the object 16 may move itself while also being moved as a result of vehicle 12 movement, which for exemplary purposes may be classified object 16 as having moved itself. The live load warning may be characterized as a motion assessment for the object 16 in so far as being indicative of the object 16 being likely to continue self-directed movements until properly secured.

Block 62 relates to a timing process for generating a timing report to indicate a duration of movement for the object 16 following communication of the live cargo warning. The timing process may be used to track occupant intervention with the object 16 after being apprised of the object 16 moving on its own. The timing process may optionally include setting a timer to track a duration of movement for the object 16 occurring before the occupant either secures the object 16 and/or dismisses the live cargo warning. The timing process may also include taking additional measures, such as slowing the vehicle 12 or limiting the driver from engaging certain operational aspects of the vehicle 12 until the self-directed movement of the object 16 is addressed. The timing process, or more particularly the data associated therewith, may be characterized as part of the motion assessment for the object 16. Block 56 may be returned to whereby the reporting process may include reporting the live cargo warning and the timing report in a manner similar to that described above.

Block 66 relates to a stationary process being implemented in response to Block 46 determining the object 16 to be present while the transmission is in park or the vehicle 12 is otherwise stationary. As opposed to the motion process associated with Block 50 being reached when an object 16 is detected while the vehicle 12 is in motion, the stationary process may be reached in the event an object 16 is detected prior to the vehicle 12 being in motion or after the vehicle 12 has been in motion and stopped or otherwise taken action whereby any movement or influence on the object 16 would be self-direct and/or as a result of external forces other than the forces imparted from driving of the vehicle 12. The stationary process may include determining a motion of the object 16 to be one of stationary or non-stationary, which may be a determination made in the illustrated manner to occur while the vehicle 12 is stationary. As with the shifting load process described with respect to Block 54, the stationary process may consider an object 16 to have motion or be in motion even if the physical location of the object 16 remains unchanged, e.g., the act of placing an object 16 on sensed surface 18, 22, 38 may be considered as motion.

Block 68 relates to a live cargo warning process for generating a live cargo warning for a driver of the vehicle 12 in response to the object 16 motion being determined as non-stationary, e.g., in response to determining the object 16 to have moved or being moved on its own. The live cargo warning process may be used to apprise the driver of moving objects 16 prior to the driver placing the vehicle 12 in gear, which may be useful in warning of the drive of live persons within the truck bed 38. The live cargo warning process may include an inhibit process or a separate inhibit process may optionally be included to inhibit movement of the vehicle 12 after generating the live cargo warning and until detecting the driver providing an acknowledgement in response thereto. The inhibit process may be used in this manner to prevent driving of the vehicle 12 until the live cargo is acknowledged by the driver. The data and other information collected and process as part of the live cargo process and the inhibit process may be characterized as part of a motion assessment for the corresponding object 16, which may be optionally reported in a manner similar to the reporting described with respect to Block 56. The present disclosure also fully contemplates optionally maintaining the inhibiting of the vehicle 12 after the driver acknowledges the live load, such as by preventing driving or other use of the vehicle 12 until the live cargo is properly secured. Block 72 may relate to a removal process whereby the inhibiting of the vehicle 12 may be removed in response to the driver acknowledgement or other desired action.

Block 74 relates to a persistence process for making a persistent presence assessment in response to the object 16 motion being stationary, which may be used to determine the object 16 to be one of an old load or a new load. The object 16 may be determined to be an old load in response to determining the object 16 to have been present during a prior ignition cycle. The object 16 may be determined to be a new load in response to determining the object 16 to have been absent during a prior ignition cycle. In the event of the object 16 being an old load, Block 76 may be reached where an old load process may be undertaken to generate an old load present warning for an occupant of the vehicle 12. In the event of the object 16 being a new load, Block 78 may be reached where a new load process may be undertaken to generate a new load present warning for an occupant of the vehicle 12 in response to determining the new load, which may optionally include identifying a size and/or a weight of the object 16 as part of the new load present warning. The data and other information collected and process as part of the persistence process and the new and/or old load warnings may be characterized as part of a motion assessment for the corresponding object 16, which may be optionally reported in a manner similar to the reporting described with respect to Block 56.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions), unless otherwise indicated expressly or clearly in view of the context, including the appended claims, are to be understood as being modified in all instances by the term “about” whether or not “about” actually appears before the numerical value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

1. An object detection and predictive motion warning system for a vehicle, comprising:
a plurality of fascia weight sensors configured to generate fascia weight values in response to pressure being applied upon a front fascia of the vehicle; and
an object detection and predictive motion controller configured to detect a leg of a passenger upon the front fascia as a function of the fascia weight values and to provide a leg warning to the passenger to remove the leg from the front fascia in response to determining the leg to be placed upon a portion of the front fascia corresponding with an airbag.

2. The object detection and predictive motion warning system according to claim 1, wherein the object detection and predictive motion controller is configured to:
perform a vehicle data collection process to collect vehicle data from vehicle systems operating onboard the vehicle;
determine object weight values for an object resting upon one more object weight sensors included within the vehicle outside of the front fascia; and
predict a motion assessment for the object as a function of the object weight values and the vehicle data, wherein the motion assessment includes determining a motion of the object to be either dependent on or independent of forces associated with the vehicle.

3. The object detection and predictive motion warning system according to claim 2, wherein the motion is determined to be dependent on the vehicle in response to the motion resulting from vehicle forces generated with movement of the vehicle.

4. The object detection and predictive motion warning system according to claim 3, wherein the object detection and predictive motion controller is configured to generate a shifting load warning for an occupant of the vehicle in response to the motion being dependent on the vehicle.

5. The object detection and predictive motion warning system according to claim 2, wherein the motion is determined to be independent of the vehicle in response to the motion resulting from non-vehicle forces generated separately from movement of the vehicle.

6. The object detection and predictive motion warning system according to claim 5, wherein the object detection and predictive motion controller is configured to generate a live cargo warning for an occupant of the vehicle in response to the motion being independent of the vehicle.

7. The object detection and predictive motion warning system according to claim 6, wherein the object detection and predictive motion controller is configured to generate a timing report for indicating a duration of movement for the object following communication of the live cargo warning.

8. The object detection and predictive motion warning system according to claim 2, wherein the motion assessment includes determining a motion of the object to be one of stationary or non-stationary while the vehicle is stationary.

9. The object detection and predictive motion warning system according to claim 8, wherein the object detection and predictive motion controller is configured to generate a live cargo warning for a driver of the vehicle in response to the motion being non-stationary.

10. The object detection and predictive motion warning system according to claim 9, wherein the object detection and predictive motion controller is configured to inhibit movement of the vehicle after generating the live cargo warning and until detecting the driver providing an acknowledgement in response thereto.

11-16. (canceled)

17. The object detection and predictive motion warning system according to claim 1, wherein the object detection and predictive motion controller is configured to generate the leg warning via a infotainment system of the vehicle.

18. The object detection and predictive motion warning system according to claim 1, wherein the object detection and predictive motion controller is configured to transmit the leg warning to a back office configured for monitoring driver behavior and safety.

19. An object detection and predictive motion warning system for a vehicle, the vehicle having a front fascia surface exposed below a front windshield, comprising:
a plurality of weight sensors configured to generate weight values in response to pressure being applied upon the front fascia surface, wherein the weight sensors are arranged in a dispersed pattern of discrete pressure sensors spread across below an outer layer of the front fascia surface as a cosmetic addition out of view or otherwise unidentifiable to a passenger in the vehicle;
an object detection and predictive motion controller configured to detect an object upon the front fascia surface and to predict a motion assessment for the object as a function of the weight values and vehicle data, the vehicle data being collected from one or more vehicle system onboard the vehicle as part of a vehicle data collection process; and
wherein the object detection and predictive motion controller is configured to perform a shifting load process in response to detecting the object to be a leg of the passenger, wherein the shifting load process provides a warning to the passenger to remove the leg from the front fascia surface upon determining the leg to be placed upon a portion of the front fascia surface corresponding with an airbag.

20. An object detection and predictive motion warning system for a vehicle, the vehicle having a truck bed and a front fascia exposed below a front windshield, comprising:
a plurality of truck bed weight sensors configured to generate truck bed weight values in response to pressure being applied to the truck bed;
a plurality of fascia weight sensors configured to generate fascia weight values in response to pressure being applied upon the front fascia, wherein the weight sensors are arranged in a dispersed pattern of discrete pressure sensors spread across below an outer layer of the front fascia out of view or otherwise unidentifiable to a passenger in the vehicle;
a plurality of vehicle systems configured to generate vehicle data for one or more operations of the vehicle; and
an object detection and predictive motion controller configured to:
detect a truck bed object upon the truck bed and to inhibit movement of the vehicle in response to the truck bed weight values and the vehicle data indicating the truck bed object to be live cargo;
detect a leg of the passenger upon the front fascia based on the fascia weight values and the vehicle data; and
provide a warning to the passenger to remove the leg from the front fascia upon determining the leg to be placed upon a portion of the front fascia corresponding with an airbag.

21. The object detection and predictive motion warning system according to claim 1, wherein the front fascia is exposed below a front windshield of the vehicle.

22. The object detection and predictive motion warning system according to claim 21, wherein the weight sensors are arranged in a dispersed pattern of discrete pressure sensors spread across below an outer layer of the front fascia surface as a cosmetic addition out of view or otherwise unidentifiable to the passenger.

23. The object detection and predictive motion warning system according to claim 19, wherein the object detection and predictive motion controller is configured to determine the object is the leg in a passive manner without interrogating or otherwise specifically identifying the object using other mechanisms besides the weight values.

24. The object detection and predictive motion warning system according to claim 19, wherein the object detection and predictive motion controller is configured to determine the object is the leg in a passive manner without reliance on a radio frequency identifiers (RFIDs).

25. The object detection and predictive motion warning system according to claim 19, wherein the object detection and predictive motion controller is configured to determine the object is the leg in a passive manner without reliance on a camera.

26. The object detection and predictive motion warning system according to claim 19, wherein the vehicle systems include one or more of a powertrain system, a braking system, an infotainment system, a navigation system, a heating, ventilation, and air conditioning (HVAC) system, a radar system, a communication system, and/or a global positioning system (GPS).
